(19) United States
(12) Patent Application Publication
(10) Pub. No.: US 2003/0002876 A1
(43) Pub. Date: Jan. 2, 2003

(54) Fluid-filled bodies for portable devices

(76) Inventor: John M. Baron, Longmont, CO (US)

Correspondence Address: HEWLETT-PACKARD COMPANY, Intellectual Property Administration, P.O. Box 272400, Fort Collins, CO, 80527-2400, US

(21) Appl. No.: 09/894,376

(22) Filed: Jun. 27, 2001

(51) Int. Cl. G03B 17/02

(52) U.S. Cl. 396/429; 396/535

(57) ABSTRACT

Generally, the present invention relates to body casings for portable devices, wherein the body casing has at least one viewable chamber for holding a material. The present invention also relates to portable devices which comprise a functional unit having a housing which is configured to include at least one viewable chamber for holding a material. Portable devices according to the invention include a functional unit having a housing surrounding at least a portion of the functional unit. The housing comprises mating inner and outer walls which define a fluid-tight chamber for holding a material. The outer wall has a transparent section to allow a viewer to perceive the contents of the chamber. Body casings for portable devices according to the invention include mating top and bottom portions which are configured to define a casing chamber for holding a portable device. At least one of the top or bottom portions includes an inner wall and an outer wall defining at least one fluid-tight chamber for holding a material.

### TECHNICAL FIELD

The present invention relates to bodies or housings for portable devices and more particularly, to bodies or housings for portable devices, wherein the body or housing has an inner and outer wall defining a fluid-fillable chamber therebetween.

### BACKGROUND

Housings for portable devices are known in the art. Typically, housings for portable devices are designed of a rigid, shatterproof material, such as hard plastic, to protect the inner workings of the portable device from damage and provide a container for the device. One drawback of prior art housings lie in their mass production. When mass produced, the consumer is not given a choice as to the color of the housing. For example, most portable electronic devices have a black plastic housing.

Prior artisans have attempted to overcome this drawback by mass producing devices with a variety of different-colored housings. This solution suffers from several drawbacks. The consumer is still left with limited choices in the color of the device, and the manufacturer may be left with a large inventory of unsold devices if a particular color is not accepted by the consuming public. The consumer is also left with a housing having an unchangeable appearance.

Other prior artisans have attempted to limit the potential for unsold inventory of devices by selling the device with a removable housing or face plate. The consumer may then purchase a colored face plate to snap on the device. If a particular color or design of a face plate does not entice the buying public's interest, the loss from unsold merchandise is minimized. However, this solution still limits the color and design of the housing to those selected by the manufacturer.

In addition, if the user wants to change the color of the device, the user is forced to purchase a new faceplate.

Still other prior artisans have attempted to allow a user to personalize a portable device by constructing a housing to include a photographic image provided by the user. For example, Nokia Corporation will make a personalized phone faceplate for a cellular phone incorporating a photograph supplied by a user for a fee. However, these personalized bodies still suffer from the drawback that the user must purchase a new faceplate if the user desires a change in the appearance of the device.

### SUMMARY OF THE INVENTION

According to the invention there is provided a housing for a portable device comprising an inner wall and an outer wall defining a chamber. At least a part of the outer wall is translucent or opaque. In accordance with one aspect of the invention, the inner wall may be solid color, opaque or translucent; or alternatively, the inner wall or outer wall may comprise a logo or design.

According to another aspect of the invention, the chamber is filled with a material. In accordance with this aspect of the invention, the material preferably comprises a single or multi-colored fluid.

According to another aspect of the invention, the housing includes a sealable port which provides access to the chamber. In accordance with this aspect of the invention, the port allows a user to change the contents of the chamber if desired.

According to yet another aspect of the invention, the housing defines a plurality of separate chambers. In accordance with this aspect of the invention, the chambers may be configured into a logo or design. Likewise, the chambers may have different colored materials or fluids therein. Further, one or more of the chambers may have a re-sealable port to allow a user to access the contents of the chambers.

According to another aspect of the invention, the housing is configured as a body cover for a portable device already having a housing.

### BRIEF DESCRIPTION OF THE DRAWINGS

FIG. 1 is a perspective view of an embodiment of a body cover for a portable device; such as a camera according to the invention; and

FIG. 2 is an exploded view of a camera body cover according to the invention.

### DETAILED DESCRIPTION

Generally, the present invention relates to a body cover for a portable device having at least one viewable chamber therein for holding at least one material, and relates to a portable device having a functional unit having a housing which is configured to include at least one viewable chamber for holding at least one material. The body covers and housings of the present invention may be configured for use in connection with any suitable device or functional unit. When used in connection with a functional unit, the housing preferably comprises the only protective housing for the unit, whereby removal of the housing (for refilling or otherwise) provides intimate access to the electronic or other components of the functional unit. When used in connection with a portable device, the housing preferably serves as a body cover for the entire device, wherein the portable device already possesses a housing. In a presently preferred embodiment, the invention is directed to a body cover for use in connection with a camera serving as the portable device to be housed. However, as will be appreciated by one of ordinary skill in the art, the concepts disclosed herein can be easily modified for a housing for a functional unit. Accordingly, the present invention should not be viewed as limited by whether a body casing or housing is desired, nor by the particular portable device or functional unit employed.

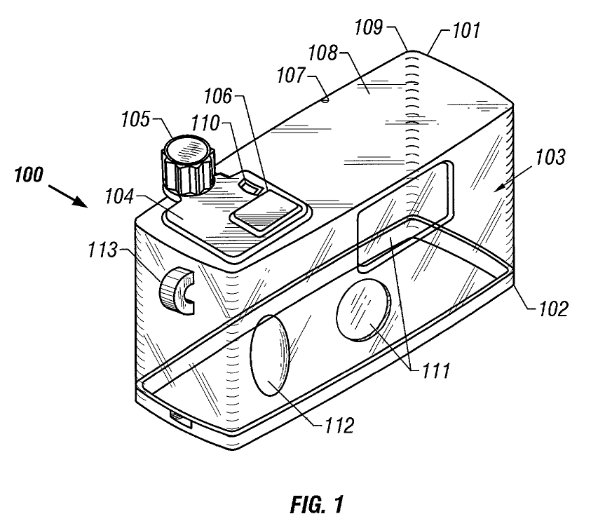

FIG. 1 depicts body cover 100 for a camera according to the invention. Body cover 100 comprises top portion 101 and bottom portion 102. Top portion 101 is configured to define chamber 103 which is sized to hold a camera. Top portion 101 is also configured to include control panel 104 which allows a user to operate a camera disposed in chamber 103. Control panel 104 includes mechanism 105 for advancing film or otherwise interacting with the camera and button 106 for activating the camera shutter release button to take a picture.

Top portion 101 comprises inner wall 107 and outer wall 108. Inner wall 107 and outer wall 108 are configured to define chamber 109 therebetween. Access to chamber 109 may be effectuated by the provision of re-sealable port 110. Preferably, re-sealable port 110 allows a user to fill chamber 109 with a material. As will be appreciated by one of ordinary skill in the art, any suitable material may be provided in chamber 109. For example, chamber 109 may be filled with a colored liquid; two differently colored, two or more immiscible liquids; liquids containing solid particles such as glitter; a powder; or any other material which allows a user to personalize body cover 100.

It is presently preferred to fill chamber 109 with fluids. Fluids are easier to remove from chamber 109 if a user desires to, for example, change the color of the device.

It is also presently preferred to construct top portion 101 out of a rigid material, such as plastic. Rigid materials resist tearing or breaking, thereby protecting contents of chamber 103 (such as an electrical device) and the user from the contents of chamber 109. Alternatively, use of a pliable material such as vinyl, may provide, in combination with a fluid filling, added mechanical protection for the camera by absorbing mechanical shock caused by dropping or otherwise bumping the container.

In a presently preferred embodiment, top portion 101 comprises clear plastic to allow a user to view the contents of chamber 109 and perhaps the contents of chamber 103. Alternatively, only outer wall 108 is translucent or opaque. Inner wall 107 may be white (to allow colored material in chamber 109 to be easily viewable) and/or include a design or logo to be viewed.

Top portion 101 also has a plurality of windows 111 which are configured to be isolated from chamber 109 and to correspond with the camera's lens and view finder so as to prevent the contents of chamber 109 from interfering with the operation of the camera. Alternatively, top portion 101 may define apertures in addition to, or instead of, windows 111. The provision of apertures may facilitate the use of certain portable devices by allowing access to the device or allowing the device to function more freely. For example, a camera with a protruding lens assembly or telescopic assembly would require an aperture in which to operate without obstruction from top portion 101.

Other windows 112 should also be provided to provide a user an unobstructed view of the device's operational features so the device does not have to be removed from body cover 100 during normal use and to provide access to other camera controls. Alternatively, the device's housing could be constructed to leave these areas unencumbered by a fluid-fillable housing according to the present invention.

Body cover 100 may also include strap holder 113 to aid the portability of the device by means of a hand strap (not shown).

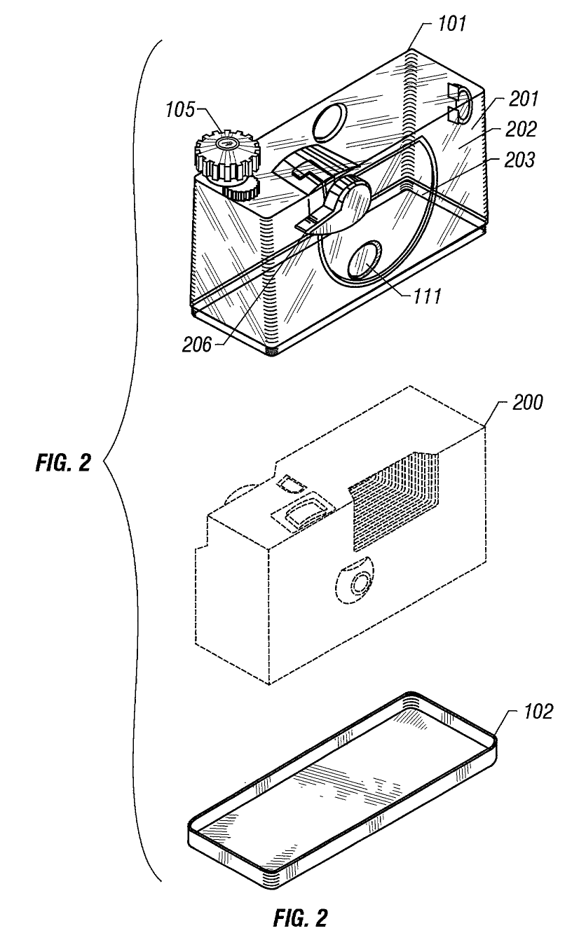

An alternate body cover configuration is shown in FIG. 2 incorporating an alternative shutter release mechanism 206 on the front of the housing.

At best, shown in FIG. 2, bottom portion 102 is configured to mate with top portion 101 to seal chamber 103 and camera device 200 disposed in chamber 103. Bottom portion 102 may comprise any suitable material and may connect to top portion 101 by any suitable means. Preferably, bottom portion 102 comprises clear hard plastic and is frictionally engageable with top portion 101. Although not shown, bottom portion may be provided with an interstitial chamber, with or without a port, for holding a material.

In accordance with the invention, chamber 109 may be configured into a design or logo, whereby when filled with a material, the logo or design is readily viewable. Also in accordance with the invention, body cover 100 may be provided with a plurality of chambers 103 whereby a plurality of materials or colors may be viewable. For example, each side of generally cubic shaped body cover 100 may comprise separate chamber 103.

Alternatively, as depicted in FIG. 2, top portion 101 may have front face 201 comprising first chamber 202 and second chamber 203.

As will be appreciated by one of ordinary skill in the art, almost any configuration of chambers is possible such that, for example, a user can personalize of portable device to have stripes of colors or organizations can configure a housing to portray a corporate logo, team mascot or team colors.

What is claimed is:

1. A portable device comprising:
a functional unit;
a housing surrounding at least a portion of said functional unit;
said housing comprising a mating inner wall and outer wall;
said inner wall and said outer wall defining a fluid-tight chamber therebetween for accepting a material within said chamber and wherein said outer wall of said chamber has a transparent section whereby a viewer can perceive a material accepted within said chamber.

2. The portable device of claim 1 wherein said housing comprises a rigid material.

3. The portable device of claim 2 wherein said rigid material comprises plastic.

4. The portable device of claim 3 wherein said plastic is translucent.

5. The portable device of claim 1 wherein said housing completely surrounds said functional unit.

6. The portable device of claim 1 wherein said inner wall and said outer wall define a plurality of chambers, each of said chambers adapted for accepting a material therein.

7. The portable device of claim 1 wherein said housing is of an integral construction.

8. The portable device of claim 1 wherein said housing comprises a plurality of pieces attached to each other or said functional unit.

9. The portable device of claim 1 wherein said material comprises a granular solid.

10. The portable device of claim 1 wherein said material comprises a colored liquid.

11. The portable device of claim 1 wherein said material comprises a plurality of differently colored immiscible liquids.

12. The portable device of claim 1 wherein said material comprises one or more colored liquids and solid flakes.

13. The portable device of claim 1 wherein said housing includes a resealable port.

14. The portable device of claim 13 wherein said housing is configured to depict a design to a viewer.

15. The portable device of claim 6 wherein one or more of said chambers includes a resealable port.

16. The portable device of claim 15 wherein the chambers of said housing are configured to depict a design to a viewer.

17. The portable device of claim 1 wherein said functional unit comprises a camera.

18. A body casing for a portable device comprising:
a top portion and a bottom portion;
said top portion configured to define a casing chamber;
said bottom portion being engageable to said top portion to seal said chamber;
one of said top and bottom portions comprising an inner wall and an outer wall;
said inner wall and said outer wall defining at least one fluid-tight chamber therebetween; and
said outer wall further defining at least one re-sealable port in communication with said fluid-tight chamber;
whereby a user may add or remove a material from said fluid-tight chamber.

19. The body casing of claim 18 wherein said housing comprises clear plastic and said material comprises a colored liquid.

20. The method of changing the perceived texture of a device, the method comprising the steps of:
surrounding at least on several sides, said device with a relatively narrow chamber; and
pouring into said chamber material representing a perceived desired texture.

21. The method of claim 20 wherein said narrow chamber defines the only housing of said device.

22. The method of claim 20 wherein said perceived texture is a color.

23. A method of encasing a portable device within a custom housing comprising the steps of:
providing a sealable housing including a liquid containing portion viewable from outside said housing.
